(19) United States
(12) Patent Application Publication
(10) Pub. No.: US 2015/0149595 A1
(43) Pub. Date: May 28, 2015

(54) SYSTEM AND METHOD FOR READING OBJECT DATA REQUIRED FOR EXECUTING OBJECT FUNCTION

(71) Applicants: INVENTEC (PUDONG) TECHNOLOGY CORPORATION, Shanghai (CN); INVENTEC CORPORATION, Taipei (TW)

(72) Inventor: Long CHEN, Shanghai (CN)

(73) Assignees: INVENTEC (PUDONG) TECHNOLOGY CORPORATION, Shanghai (CN); INVENTEC CORPORATION, Taipei (TW)

(21) Appl. No.: 14/291,716

(22) Filed: May 30, 2014

(30) Foreign Application Priority Data
Nov. 27, 2013 (CN) 201310616579.X

(51) Int. Cl. H04L 29/06

(52) U.S. Cl. CPC H04L 67/42
USPC 709/219

(57) ABSTRACT

A system and method for pre-reading a object data required for executing a object function according to the present invention are disclosed. In the system and method of the present invention, a server reads a function identification (ID) corresponding to an ID from a client after connecting to the client, and transmits a object data required for executing the object function corresponding to the read function ID to the client and the client stores such object data, so that the client may directly uses the stored object data to generate an execution result when the client executes such object function, whereby reducing a resource of the server required for executing the object function and thus solving the issue existing in the prior art.

### BACKGROUND OF THE RELATED ART

1. Technical Field

The present invention pertains to a function executing system and method, and particularly to a system and method for pre-reading a object data required for executing a object function.

2. Related Art

With development of technology, more and more application software presents a user interface and an executed result by employing a webpage, or acquires data required for execution of some functions by connecting to a server using an application software and then processes the acquired data to generate an execution result.

In the described application software, it is a common feature that the application software requests data particularly for execution of some function through the Internet form the server, and a subsequent process is made on the received data for execution of the particular function. In executing the particular function as described above, the time for finishing the particular function may be influenced by a speed for reading data from the server, a speed of data transmission through the Internet, and a speed for processing data by the application software. In the case that a large of data amount is required for the selected function by a user, the user has to wait for a period of time to have the execution result available.

In view of the above, it may be known that the issue of an overly long execution time has been long encountered when the data amount required for execution of a function is large. In response, there is quite a need to set forth an associated technology and means for improvement.

### SUMMARY

In view of the issue of an overly long execution time has been long encountered when the data amount required for execution of a function is large, the present invention discloses a system and method for pre-reading a object data required for executing a object function.

The system and for pre-reading a object data required for executing a object function according to the present invention comprises a client; a sever, comprising; a server transmission module, providing a client to connect to a server by using an identification (ID) by the server; an ID recording module, recording the ID and a function ID for each of at least a object function selected by the client, when the client selects the object function to be provided from the server; a common usage analyzing module, determining the function ID corresponding to the ID provided from the server; an ID reading module, reading the function ID according to the ID corresponding thereto by the server, when the client connects to the server again by using the ID; and a data reading module, reading the object data required for executing the object function corresponding to the read function ID by the server, and transmitting the read object data to the client and storing the read object data at the client by the server, wherein the client determines if the object data required for executing the selected object function has been stored when the object function is selected, and generates an execution result by using the object data when the object data required for executing the selected object function is determined as having been stored.

The method for pre-reading a object data required for executing a object function according to the present invention comprises steps of providing a client to connect to a server by using an identification (ID) by the server; recording the ID and a function ID for each of at least a object function selected by the client, when the client selects the object function to be provided from the server; determining the function ID corresponding to the ID by the server; reading the function ID according to the ID corresponding thereto by the server, when the client connects to the server again by using the ID; reading the object data required for executing the object function corresponding to the read function ID by the server; transmitting the read object data to the client and storing the read object data at the client by the server; determining if the object data required for executing the selected object function has been stored by the client when the object function is selected; and generating an execution result by using the object data at the client, when the object data required for executing the selected object function is determined as having been stored.

The system and method of the present invention have the differences as compared to the prior art that the server reads the function ID corresponding to the ID from the client after connecting to the client, and transmits the object data required for executing the object function corresponding to the read function ID to the client and the client stores such object data, so that the client may directly uses the stored object data to generate an execution result when the client executes such object function, whereby reducing a resource of the server required for executing the object function and thus solving the issue existing in the prior art.

### BRIEF DESCRIPTION OF THE DRAWINGS

The present invention will become more fully understood from the detailed description given herein below illustration only, and thus is not limitative of the present invention, and wherein:

FIG. 1 is a schematic diagram of elements of a server in pre-reading a object data required for executing a object function according to the present invention;

FIG. 2 is a schematic diagram of elements of a client in pre-reading the object data required for executing the object function according to the present invention;

FIG. 3A is a flowchart of a method for pre-reading the object data required for executing the object function according to the present invention; and

FIG. 3B is a flowchart of an additional data updating method according to the present invention.

### DETAILED DESCRIPTION

The present invention will be apparent from the following detailed description, which proceeds with reference to the accompanying drawings, wherein the same references relate to the same elements. With reference to the detailed description, those skilled in the art may use the technical skill to solve the associated problem and thus achieve in the technical efficacy associated therewith, namely, may be enabled to implement the present invention.

The present invention is capable of determining some commonly used functions by every user, and pre-loading data required for executing the commonly used functions when the user logs into a sever from a client according to the present invention, whereby generating an execution result by directly using the pre-loaded data when the user selects to execute the commonly used functions. In the specification, the selected and executed functions are in fact one or more, but randomly recited as being in singularity or plurality.

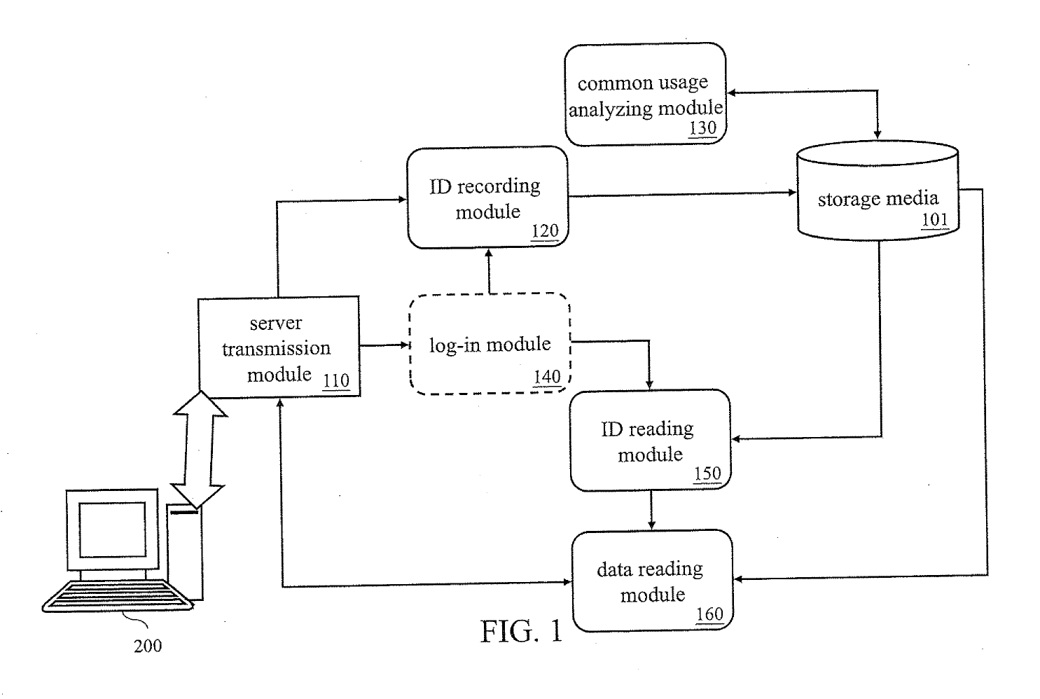

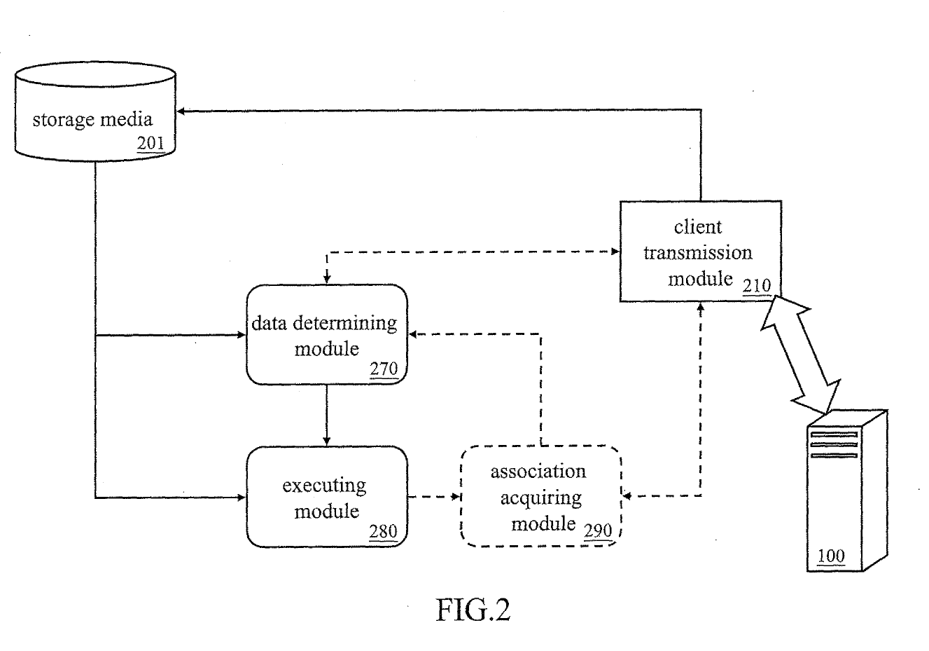

Referring to FIG. 1 and FIG. 2 first, the system operation according to the present invention is described with reference thereto. The system of the present invention comprises a server 100 and a client 200.

The sever 100 provides the data required for executing the functions as requested from the client 200, and captures the commonly selected functions at the client 200. As shown in FIG. 1, the server further comprises a sever transmission module 110, an identification (ID) recording module 120, a common usage analyzing module 130, ID reading module 150, and a data reading module 160.

The server transmission module 110 provides the client 200 to connect to the server 100. Generally, the server 100 may request the client 200 to provide an ID after the client 200 is connected onto the sever 100.

The ID provided by the present invention may be a one-to-one relationship and is used to represent the ID of the user. For example, the ID may a user account. The ID may also be data for identifying the client 200, such as a cookie. However, the ID as mentioned in the present invention is not limited to the examples.

The ID recording module 120 records the ID and a function ID for each of the object function selected by the client 200, when the client 200 selects the object function to be provided from the server 100.

In some embodiments, the client 200 may transmit the function ID corresponding to the selected function (described as hereinbelow “object function”). In this manner, the ID recording module 120 may receive the function ID corresponding to the object function selected from the client 200. However, the manner for the ID recording module 120 acquiring the function ID corresponding to the object function selected at the client 200 is not limited to the example.

Generally, the ID recording module 120 takes the function ID and the ID as a set of data and store the data set into the storage media 101. The storage media 101 is arranged in the server 100. However, the present invention is not limited to the example, i.e. the storage media 101 may also be arranged in other devices connected to the server 100.

The common usage analyzing module 130 determines the function ID corresponding to the ID provided by the client 200. As analogously mentioned above, the function ID may have several sets, as the commonly used functions may be several besides one. In some embodiments, the common usage analyzing module 130 may calculate a number of the function ID set recorded together with the ID. When the function ID set number is beyond a predetermined value, the common usage analyzing module 130 may also calculate a proportion of a particular one among all the function ID sets recorded together with the same ID. When the calculated proportion reaches a predetermined value, the common usage analyzing module 130 determines the function ID sets having the proportion up to the determined value as corresponding to the ID. However, this is also an example, without limiting the common usage analyzing module 130 and thus the present invention.

Generally, the common usage analyzing module 130 may determine the function ID corresponding to the ID provided by the client 200 in a fixed time period, such as every eight hours, every day, and every two weeks. The common usage analyzing module 130 may determine the function ID corresponding to the ID provided by the client 200 at a particular time point, such as the time when the server transmission module 110 receives the function ID transmitted from the client 200, and the time when the client 200 is connected to the server 100. However, the common usage analyzing module 130 is not merely limited to this determination time for the function ID corresponding to the ID provided from the client 200.

The ID reading module 150 acquires the ID used at the client 200 through the server transmission module 110 the function ID, when the client connects to the server by using the ID. The ID reading module 150 further reads from the storage media 101 the function ID corresponding to the ID used at the client 200 determined by the common usage analyzing module 130.

The data reading module 160 reads the data required for executing the function provided by the server, and transmits the read data to the client 200 through the server transmission module 110.

The data reading module 160 may read the object data required for the object function corresponding to the function ID after the reading module 150 the function ID, and may also read the data required for the function corresponding to the function ID after the server transmission module 110 receives the request containing the function ID transmitted form the client 200.

In some embodiments, the data reading module 160 may use the currently available technology to read data required for execution of the function from the storage media 101. For example, the data reading module 160 may search the data required for execution of the selected functions in a data library according to each definition of the selected functions, respectively. However, it is not intended to limit the data reading module 160 to merely have the manner for reading data required for function execution.

In addition, the server 100 may further comprises an additional log-in module 140, which is used for logging into the server 100 for the client 200 after the client 200 is connected to the server 100.

Referring next to FIG. 2, the client 200 connects the server 100 and generates an execution result according to the data provided by the server 100. The client 200 further comprises a client transmission module 210, a data determining module 270, and an executing module 280. It is to be noted that in some embodiments, the client 200 executes a particular program code to generate the data determining module 270 and the executing module 280 after the server 100 transmits the program code to the client 200. However, this is not to limit the present invention.

The client transmission module 210 connects the server 100, and transmits the ID to the server 100 in the course of server 100.

The client transmission module 210 receives the data required for executing the function from the server 100, and stores the received data. Generally, the client transmission module 210 may store the received data in a temporary memory or the storage media 201 at the client 200.

The data determining module 270 determines the object data required for executing the selected object function when the object function provided by the server 100 is selected. Generally, the data determining module 270 may compare the function ID of the selected object function with an index of the stored data. If the index meeting up with the function ID exists, it is indicated that the object data required for the selected object function has been stored. Otherwise, such object data is indicated as having not been stored. However, the data determining module 270 is not limited to the above example as to the determination of the storing manner of such object data.

When the data determining module 270 determines the object data required for executing the selected object function as having been stored, the executing module 280 directly generates an execution result by using the stored object data, such as establishing a result picture frame according to the stored object data and operating the stored object data to output the operational result. However, the executing module 280 is not limited to this example as to the generation manner of the object function. As such, the executing module 280 does not need to request a object data from the server 100 whenever executing the object function, reducing the time required for generation of the execution result and reducing the use for the resource of the server 100.

When the data determining module 270 determines the object data required for executing the selected object function as having not been stored, the executing module 280 may request the object data required for executing the selected object function from the server 100 through the client transmission module 210, and then uses the acquired object data to generate an execution result, as being the currently available technology

In addition, the client 200 may further comprises an additional association acquiring module 290, which is used to acquire one or more candidate functions associated with the selected object function. In the present invention, the term “association” refers to the case where the same data may be used when the object function is executed and when the candidate function is executed. Consequently, when the object function or the candidate function is executed, if the same data is changed, the accuracy of the execution result generated when the subsequent execution of the candidate function or the object function is performed.

The association acquiring module 290 may request a candidate function having the association with the selected object function through the client transmission module 210 from the server 100, and may also search from some pre-established associated data, so as to read out the object data associated with the selected object function from the associated data. However, the association acquiring module 290 is not limited to what the above describes as to acquisition of the candidate function associated with the selected object function. In addition, the read object data from the association acquiring module 290 is additionally termed as “to-be-processed” data.

If the selected object function has its associated candidate function, the data determining module 270 may further determine if the to-be-processed data required for executing the candidate functions have been stored. If yes, the data determining module 270 may request the to-be-processed data required for executing the candidate functions from the server 100 through the client transmission module 210, and the client transmission module 210 receives and stores the to-be-processed data transmitted back from the server 100.

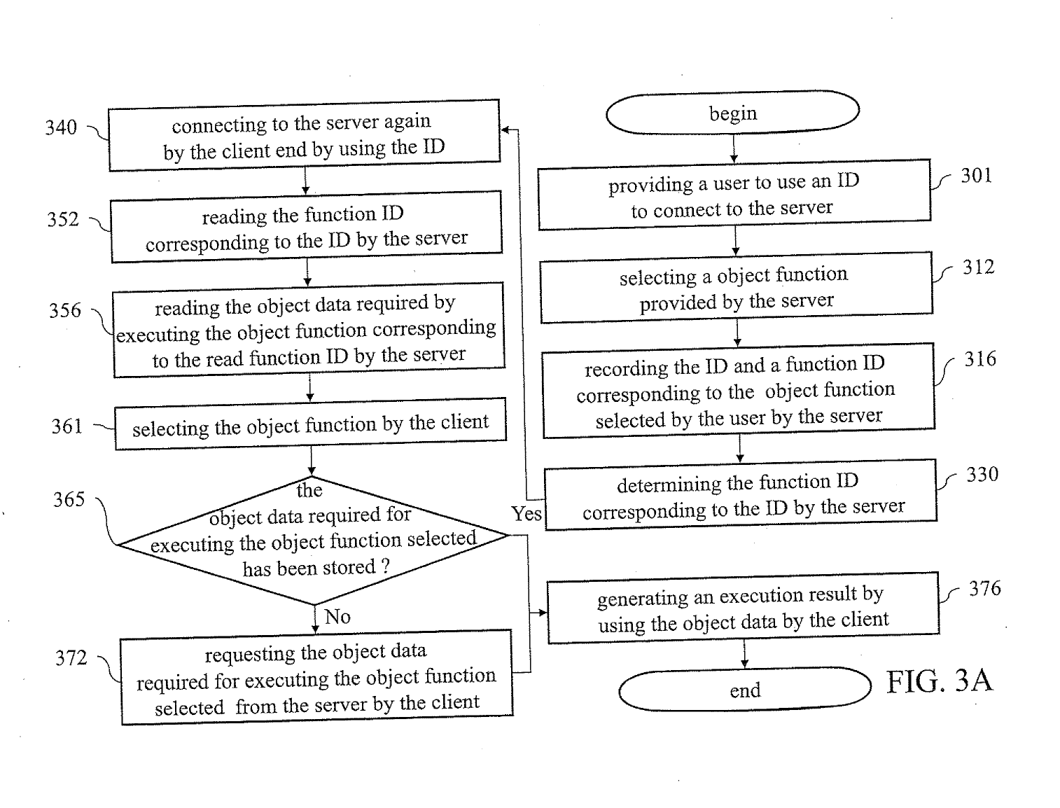

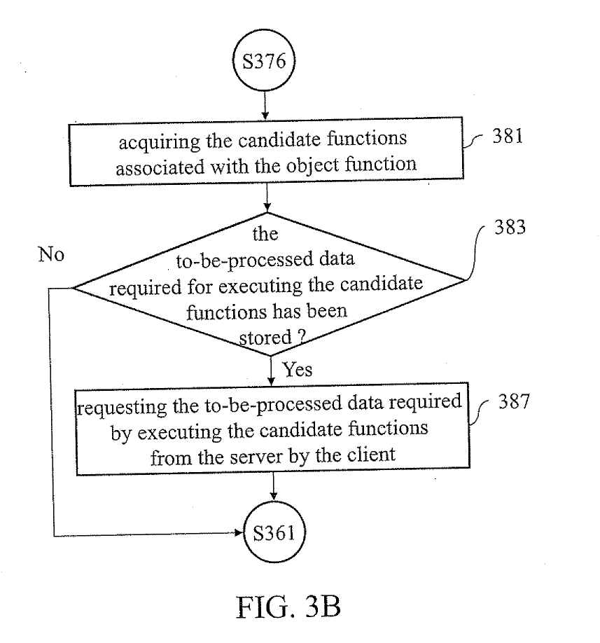

Thereafter, an embodiment is set forth to explain how the system and method of the present invention operate, with reference to FIG. 3A, in which a flowchart of the method for pre-reading the object data required for executing the object function according to the present invention is shown. In this embodiment, the server 100 is assumed as a web server, while the client 200 a browser, which are merely examples, without limiting the present invention.

At first, the server transmission module 110 of the server 100 may provide the user at the client 200 to operate the client 200 to use the ID to connect to the server 200 (S301). In this embodiment, assume that the server transmission module 110 will transmit a webpage including a set of ID such as account and password to be inputted to the client 200, which requires the user to operate the client 200 to input the ID in the webpage transmitted from the server transmission module 110. Thereafter, the client transmission module 210 transmits the ID inputted by the user back to the server 200. In practice, the webpage on which the user operates the client 200 to input the ID may also be pre-stored at the client 200, but which is merely an example, without limiting the present invention.

After the sever transmission module 110 of the server 100 receives the ID transmitted back from the client 200, in the case where the server 100 includes a log-in module 140, the log-in module 140 may check out if the ID inputted by the user is correct. If yes, the server allows the client 200 to maintain the connection state, and even further determine the functions executable by the user according to the ID. Otherwise, the server 100 denies any connection from the client 200.

In the case where the server 100 comes up without the log-in module 140, or the log-in module 140 allows the client 200 to maintain the connection state, the server transmission module 110 of the server 100 may transmit the webpage including the executable functions' names by the user and the function ID to the client 200. In practice, the client 200 may also pre-store the webpage including the names of all the executable functions and the function ID sets. Upon receiving the ID transmitted back from the client 200, the server transmission module 110 transmits an authority-limit control data to the client 200. In response, the client 200 selects to display the names of the executable functions in the webpage according to the received authority-limit control data.

After the client 200 displays the webpage including the functions provided by the server 100, the client 200 select the object functions to be executed (S312). In this embodiment, assume the user may select for some object function to connect in the webpage displayed at the client 200, then the client transmission module 210 of the client 200 will transmit the function ID of the object function selected by the user to the server 100. At the same time, the client 200 may also use the pre-stored object data required for executing the object function selected by the user to generate an execution result, or use the object data required for executing the object function selected by the user requested from the server 100 to generate the execution result.

After the server transmission module 110 of the server 100 receives the function ID transmitted from the client 200, the ID recording module 120 of the server 100 may record the ID used by the client 200 and the function ID transmitted by the client 200 (S316). In this embodiment, assume the ID recording module 120 takes the ID used by the client 200 and the function ID transmitted by the client 200 as a set of data, and the set of data is stored into the storage media 101.

Thereafter, the common usage analyzing module 130 of the server 100 may determine the function ID corresponding to the ID used by the client 200 (S330). In this embodiment, assume the common usage analyzing module 130 will calculate and record a total number of all the date of each of the ID sets and a total number of the function ID sets within the same set of data recorded together with the same ID. Further, a ratio of the total number of all the data of each of the ID sets to the total number of the ID sets including a particular ID is calculated, and the then the function ID having the calculated ratio beyond a predetermined value is determined as corresponding to the ID.

For example, in the data stored in the storage media 101, three different kinds of ID are included. The first kind of ID includes seventy seven sets, the second kind of ID includes sixty nine sets, and the third kind of ID includes twenty seven sets. If in the third ID record, four different kinds of function ID are included, two sets, eight sets, four sets, and thirteen sets, and the common usage analyzing module 130 is assigned with a predetermined ratio of 25%, the ratio of eight sets and 13 sets of function ID in the record to the entire function ID sets are 29.6% and 48%, respectively, and both meet up with the standard beyond the predetermined value. However, the cases of four and seven sets of function ID do not reach the predetermined value. Therefore, the common usage analyzing module 130 determines the eight and thirteen sets of function ID as corresponding to the third kind of ID.

After the common usage analyzing module 130 of the sever 100 has determines the function ID corresponding to the ID used by the client 200 (S330), when the client 200 uses again the same ID to connect to the server 100 (S340), the server transmission module 110 of the server 100 may receive the ID provided by the client 200, and the ID reading module 150 of the sever 100 may read the function ID corresponding to the ID received by the server transmission module 110 (S352).

Subsequently, the data reading module 160 of the server 100 may read the object data required by the object function corresponding to the function ID read by the ID reading module 150 (S356). In this embodiment, assume the data reading module 160 has read the object data of the object function “online user information”, including email addresses and used devices of the online users.

After the data reading module 160 of the server 100 has read the object data, the server transmission module 110 of the server 100 may transmit the object data read out by the data reading module 160 to the client 200. After the client transmission module 210 of the client 200 receives the object data transmitted by the server 100, the received object data may be stored. In this embodiment, assume the client 200 uses the article of “sessionStorage” of HTML 5, which may store the object data in a memory used at the client 200.

At the same time, the client 200 uses again the same ID to connect to the server 100 (S340), and then the server transmission module 110 of the server 100 may transmit the webpage including the names of the executable functions by the user and the function ID to the client 200, so that the client 200 may display the webpage transmitted by the server 100.

After the user operates the client 200 to select the object function provided by the server 100 displayed by the server 100 (S361), the client transmission module 210 of the client 200 transmits to the server 100 the function ID corresponding to the object function selected by the user, so that the ID recording module 120 of the server 100 may record the ID used at the client 200 and the function ID corresponding to the object function selected by the user (S316), whereby a subsequent process may be conducted by the later common usage analyzing module 130 of the server 100.

At the same time, the data determining module 270 of the client 200 may determine if the object data required for executing the object function selected by the user has been stored (S365) (S365). In this embodiment, assume the user has selected the object function of “online user information”, the data determining module 270 may search if the object data required for executing the object function “online user information” exists in the object data stored by the “sessionStorage” of HTML 5.

Since the object data corresponding to the object function “online user information” has been pre-stored in the article “sessionStorage”, the data determining module 270 may determine the object data required for executing the object function “online user information” has been stored. As such, the executing module 280 of the client 200 may generate the execution result by directly using the object data stored in the article “sessionStorage” (S376). In this manner, when the user desires to execute the object function corresponding to the ID used at the client 200 determined from the common usage analyzing module 130 of the server 100, i.e. when he/she desires to execute his/her commonly used functions, the client 200 may not request from the server 100 the object data required for executing the object function, he/she can generate the execution result by directly using the pre-stored object data required for executing the object function, and further reduce the time for executing the object function and reduce the use of the resource of the server 100.

In addition, if in this embodiment the object data required for executing the object function selected by the user has not been stored in the article “sessionStorage”, the data determining module 270 may determine the case without being stored of such object data, and may then request from the server the object data required for executing the object function selected by the user through the client transmission module 210 (S372). In this case, the data determining module 270 may add the function ID required by the object function selected by the user into the request for the object data transmitted from the client transmission module 210.

After the request for the object data from the client 200 is received at the server 100 by the server transmission module 110, the data reading module 160 of the server 100 may read the object data required for executing the object function corresponding to the function ID contained in the request received by the server transmission module 110, and transmit the required object data to the client 200.

After the object data is received by the client transmission module 210 of the client 200 from the server 100, the executing module 280 of the client 200 may use the object data received at the client transmission module 210 to generate the execution result (S376). In this embodiment, it is assumed that the client transmission module 210 stores first the received object data into the article “sessionStorage”, and then the executing module 280 reads from “sessionStorage” the object data required by the object function selected by the user to generate the execution result according to the read object data.

In the above embodiment, after the executing module 280 of the client 200 generates the execution result by using the object data, if the client 200 further comprises an association acquiring module 290, the association acquiring module 290 may acquire the candidate functions associated with the object function selected by the user (S381), as is shown in FIG. 3B. In this embodiment, it is assumed that the webpage transmitted by the server transmission module 110 of the server 100 has included the information of the candidate functions associated with the object functions, such as the information of function ID corresponding to the candidate functions associated with the object functions and the function ID corresponding to the object functions. As such, the association acquiring module 290 may acquire the candidate functions associated with the object functions selected by the user according to the information recorded on the webpage.

After the association acquiring module 290 of the client 200 acquires the candidate functions associated with the object function selected by the user (S381), the determining module 270 of the client 200 may determine if the to-be-processed data required for executing the candidate functions has been stored (S383). In this embodiment, the data determining module 270 may determine if the to-be-processed data required for executing the candidate functions by searching from the article “sessionStorage” by using the same way performed by determining if the object data required for executing the object functions. If yes, the data determining module 270 may request the to-be-processed data required for executing the candidate functions from the server through the client transmission module 210 of the client 200 (S387).

After the request for the transmission of the to-be-processed data from the client 200 is received at the server transmission module 110 of the server 100 is successful, the data reading module 160 of the server 100 may read the to-be-processed data required for executing the candidate functions corresponding to the function ID contained in the request received at the server transmission module 110, and the server transmission module 110 may transmits the to-be-processed data to the client 200.

After the client transmission module 210 of the client 200 receives the to-be-processed data is received at the client transmission module 210, the received object data may be stored into the article “sessionStorage”, by which the to-be-processed data required for executing the candidate functions may be updated.

In view of the description above, the system and method of the present invention, have the differences as compared to the prior art that the server reads the function ID corresponding to the ID from the client after connecting to the client, and transmits the object data required for executing the object function corresponding to the read function ID to the client and the client stores such object data, so that the client may directly uses the stored object data to generate an execution result when the client executes such object function, whereby reducing a resource of the server required for executing the object function and thus solving the issue existing in the prior art.

Furthermore, the method for pre-reading a object data required for executing a object function according to the present invention may be implemented in a hardware, a software or a combination thereof. Alternatively, the method may also be implemented in a single unit or separate computer systems connected with one another with discrete components arranged therein.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for pre-reading a object data required for executing a object function, comprising steps of:
providing a client to connect to a server by using an identification (ID) by the server;
recording the ID and a function ID for each of at least a object function selected by the client, when the client selects the object function to be provided from the server;
determining the function ID corresponding to the ID by the server;
reading the function ID according to the ID corresponding thereto by the server, when the client connects to the server again by using the ID;
reading the object data required for executing the object function corresponding to the read function ID by the server;
transmitting the read object data from the server to the client and storing the read object data by the client;
determining if the object data required for executing the selected object function has been stored by the client when the object function is selected; and
generating an execution result by using the object data at the client, when the object data required for executing the selected object function has been stored.

2. The method as claimed in claim 1, further comprising a step of requesting the object data required for executing the selected object function from the server and generating the execution result by using the object data by the client, when the object data required for executing the selected object function is has not been stored.

3. The method as claimed in claim 1, further comprising a step of requesting a to-be-processed data required for executing at least a candidate function associated with the object function from the server and storing the to-be-processed data at the client, when the client determines the to-be-processed data required for executing the candidate function has been stored according to the candidate function, after the step of generating the execution result by using the object data by the client.

4. The method as claimed in claim 1, wherein the step of connecting to the server by using the ID by the client further comprises a step of logging into the server by the client.

5. A system for pre-reading a object data required for executing a object function, comprising:
a client; and
a sever, comprising;
a server transmission module, providing the client to connect to the server by using an identification (ID);
an ID recording module, recording the ID and a function ID for each of at least a object function selected by the client, when the client selects the object function to be provided from the server;
a common usage analyzing module, determining the function ID corresponding to the ID provided from the client;
an ID reading module, reading the function ID according to the ID corresponding thereto, when the client connects to the server by using the ID; and
a data reading module, reading the object data required for executing the object function corresponding to the read function ID, and transmitting the read object data to the client,
wherein the client determines if the object data required for executing the selected object function has been stored when the object function is selected, and generates an execution result by using the object data when the object data required for executing the selected object function has been stored.

6. The system as claimed in claim 5, wherein the client requests the object data required for executing the selected object function from the server and generates the execution result by using the object data, when the object data required for executing the selected object function has not been stored.

7. The system as claimed in claim 5, wherein the client requests a to-be-processed data required for executing at least a candidate function associated with the object function and stores the to-be-processed data, when the client determines the to-be-processed data required for executing the candidate function has been stored according to the candidate function.

8. The system as claimed in claim 5, wherein the server further comprises a log-in module providing the client to log into the server.

9. The system as claimed in claim 5, wherein the server is a web server and the client is a browser.

10. The system as claimed in claim 5, wherein the client stores the object data at a temporary memory or a particular file at the client.
